(19) United States
(12) Patent Application Publication
(10) Pub. No.: US 2012/0326980 A1
(43) Pub. Date: Dec. 27, 2012

(54) COMMUNICATION OF USER INPUT

(75) Inventor: Carey Sonsino, Golden, CO (US)

(73) Assignee: CABLE TELEVISION LABORATORIES, INC., Louisville, CO (US)

(21) Appl. No.: 13/169,119

(22) Filed: Jun. 27, 2011

(51) Int. Cl. G09G 5/08

(52) U.S. Cl. 345/158

(57) ABSTRACT

A keyboard application operably configured to facilitate user inputs through a keyboard displayed within a screen or other user-viewable interface by way of signaling received from a remote control. The application may be configured to facilitate user selection of one or more keys with the use of shortcuts buttons on the remote control that allow the user to navigate to different areas of the keyboard in a more efficient manner. The application may be operable with an interactive television (iTV) system to facilitate interfacing user requests with an output device and other system associated with a multiple system operator (MSO), such as to support interfacing user inputs required to enable product purchasing, navigation of an electronic programming guide (EPG), instigation of video on demand (VOD), textual messaging, web browsing, etc.

### TECHNICAL FIELD

The present invention relates to facilitating identification of user inputs to an application, such as but not necessarily limited to facilitating identifying user inputs according to signaling originating from a remote control associated to an interactive television application executing on a settop box (STB).

### BACKGROUND

A number of different types of electronic devices facilitate communication of user inputs to an application. One popular type of input device is a keyboard/keypad having a number of user compressible alphanumeric keys. The use of QWERTY keyboards is particularly prevalent in facilitating textual entry related operations. Some devices and applications that covet the textual entry convenience and layout familiarity associated with a common keyboard are not conducive to the use of a keyboard. These applications, in some cases, mimic the common keyboard by displaying a keyboard on a screen or other interface with which a user may interact. The on-screen keyboard may be facilitated with a touch-screen so that the user can simply touch a portion of the screen proximate a desired key to initiate communication of the related user input.

The interaction with the on-screen keyboard can be problematic since it requires the user to be within reach of the screen in order to register the desired input. Accordingly, a need exist to facilitate communication of the on-screen user input without requiring the user to be within reach of the screen or other device upon which the keyboard is displayed.

### SUMMARY

One non-limiting aspect of the present invention contemplates facilitating identification of user inputs to an on-screen keyboard or other interface according to signaling originating from a remote control. The remote control may be configured to emit signals such that user inputs are identified without requiring a user to be within an arm's reach of the screen. An application operation of the device desiring the user inputs may be configured to facilitate positioning a cursor within the on-screen keyboard according to the signaling received from the remote control. In this manner, the user may view the on-screen keyboard and direct input of keyboard related commands by selecting the appropriate key with the cursor and actuating the input with the remote control.

One non-limiting aspect of the present invention contemplates a method of identifying user inputs to an on-screen keyboard having a plurality of on-screen keys. The method may include: positioning of a cursor within the on-screen display according to signals generated in response to user actuation of remote control buttons included on a remote control, the positioning including moving the cursor in a sequential pattern when a first one or more of the remote control buttons is actuated and in a non-sequential pattern when a second one or more of the remote control buttons is actuated; and identifying user inputs according to the on-screen key in which the cursor is positioned.

One non-limiting aspect of the present invention contemplates positioning the cursor in the sequential pattern by moving the cursor one key at a time with each actuation of the first one or more of the remote control buttons.

One non-limiting aspect of the present invention contemplates positioning the cursor in the non-sequential pattern by moving the cursor from one on-screen key to a non-adjoining on-screen key.

One non-limiting aspect of the present invention contemplates associating one or more of the second one or more of the remote control buttons with a different one of the on-screen keys whereby positioning the cursor in the non-sequential pattern includes automatically moving the cursor to the on-screen key associated with an actuated one of the second one or more of the remote control buttons.

One non-limiting aspect of the present invention contemplates: representing each of the on-screen keys with a unique graphical representation reflective of the corresponding user input; and providing each of the on-screen keys associated with the second one or more of the remote control buttons with an additional graphical representation reflective of the second one or more of the remote control buttons.

One non-limiting aspect of the present invention contemplates the additional graphical representation is at least one of a yellow-colored background, a red-colored background, a green-colored background, a blue-colored background, a circle-shaped background, a square-shaped background, a diamond-shape background and a triangle-shaped background

One non-limiting aspect of the present invention contemplates the second one or more of the remote control buttons is at least one of a yellow-colored button, a red-colored button, a green-colored button, a blue-colored button, a circle-shaped button, a square-shaped button, a diamond-shape button, and a triangle-shaped button.

One non-limiting aspect of the present invention contemplates the first one or more of the remote control buttons is at least one of an up button, a down button, a left button, and a right button.

One non-limiting aspect of the present invention contemplates method of positioning a cursor relative to a plurality of keys of a keyboard according to signaling generated responsively to actuation of remote control buttons included on a remote control. The method may include: facilitating movement of the cursor from a first key to a second key in a first manner in response to at least one actuation of a first one or more of the remote control buttons, the first manner changing positioning of the cursor from the first key to at least one intermediary key prior to be being positioned at the second key; and facilitating movement of the cursor from the first key to the second key in a second manner in response to at least one actuation of a second one or more of the remote control buttons, the second manner providing a shortcut past the at least one intermediary key such that the cursor changes positioning from the first key directly to the second key.

One non-limiting aspect of the present invention contemplates the first manner changing positioning of the cursor starting from the first key to an adjoining key with each actuation of the first one or more of the remote control buttons.

One non-limiting aspect of the present invention contemplates the second manner changing positioning of the cursor starting from the first key directly to the second key with a single actuation of the second one or more of the remote control buttons.

One non-limiting aspect of the present invention contemplates facilitating assigning each of the second one or more of the remote control buttons to a different one of the plurality of keys, the second key thereby corresponding with a currently actuated one of the second one or more of the remote control buttons.

One non-limiting aspect of the present invention contemplates automatically assigning each of the second one or more of the remote control buttons based on a corresponding most popular ones of the plurality of keys as measured from prior user inputs.

One non-limiting aspect of the present invention contemplates: facilitating representation of each of the plurality of keys with a unique icon representative of the corresponding key; facilitating representation of each of the plurality of keys assigned to the second one or more of the remote control buttons with a unique background representative of the assigned second one or more of the remote control buttons; and facilitating simultaneously representation of each icon and each background.

One non-limiting aspect of the present invention contemplates computer-readable medium having stored thereon a plurality of instructions including instructions which, when executed by a processor operating in cooperation with a display screen and an input configured to receive wireless signal from a remote control, cause the processor to: display a keyboard having a plurality of keys on the display screen in response to user actuation of a corresponding button of the remote control; position a cursor relative to a first key of the plurality of keys upon display of the keyboard; move the cursor from the first key in response to user actuation of at least one of a plurality of directional buttons of the remote control, the directional buttons specifying an adjoining key to which the cursor moves; move the cursor from the first key in response to user actuation of at least one of a plurality of shortcut buttons of the remote control, the shortcut buttons each specifying a different one of the plurality of keys to which the cursor moves; and represent user input based on the one of the plurality of keys having the cursor upon actuation of a select button of the remote control.

One non-limiting aspect of the present invention contemplates having instructions which cause the processor to separately identify the different one of the plurality of keys with an image reflective of the shortcut button that causes the cursor to move there.

One non-limiting aspect of the present invention contemplates having instructions which cause the processor to execute a set-up operation during which user actuation of the directional buttons is required to position the cursor within the keyboard to facilitate selection of the keys to be reached upon actuation of the shortcut buttons.

One non-limiting aspect of the present invention contemplates having instructions which cause the processor to move the cursor no more than one adjoining key at a time for each actuation of the directional buttons.

One non-limiting aspect of the present invention contemplates having instructions which cause the processor to determine the first key to be a farthest corner of the keyboard and the different one of the plurality of keys moved to with the shortcuts buttons to be non-adjoining to the first key, wherein movement of the cursor from the first key to any one of the different one of the plurality of keys using the directional buttons requires more actuations of the remote control buttons than movement of the cursor to the same key using the shortcut buttons.

One non-limiting aspect of the present invention contemplates having instructions which cause the processor to represent the user input to an interactive television (iTV) application operating on a settop box (STB), the STB being operable to process television signaling for viewing on the display.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a keyboard-based entry system as contemplated by one non-limiting aspect of the present invention

FIG. 2 illustrates a remote control as contemplated by one non-limiting aspect of the present invention.

FIG. 3 illustrates a keyboard as contemplated by one non-limiting aspect of the present invention.

FIG. 4 illustrates a a plurality of shortcut references as contemplated by one non-limiting aspect of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

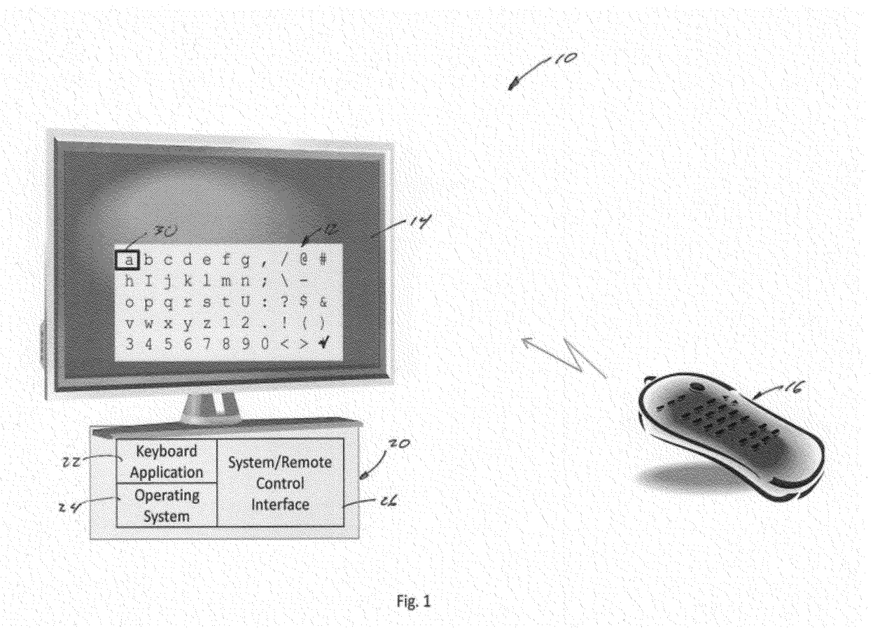

FIG. 1 illustrates a keyboard-based entry system 10 as contemplated by one non-limiting aspect of the present invention. The system 10 relates to supporting communication of user inputs made to a keyboard 12 or other suitable interface displayed on a screen 14 based on wireless or wireline signaling originating from user interaction with a remote control 16. The system 10 allows a user to be positioned away from the keyboard 12 when directing input of keyboard related commands with a device being less number of inputs than that which are available through the keyboard 12. The present invention is predominately described with respect to an exemplary application where a settop box (STB) 20 is provided from a multiple system operator (MSO) is configured with a keyboard application 22 to facilitate user inputs needed to support interactive television (iTV) operations. This is done for exemplary non-limiting purposes as the present invention fully contemplates its application to any environment where it is desirable to communicate user inputs respective to a keyboard or other display by way of signaling communicated from a remote control.

The STB 20 may include an operating system 24 operably configured to facilitate execution of the keyboard application 22 and signaling through a system/remote control interface 26 configured to support communications between a MSO network (not shown), the screen 14, and/or the remote control 16. The keyboard application 22 may be embodied in a computer-readable medium (not shown) having stored thereon a plurality of instructions including instructions which, when executed by a processor (not shown) operating in cooperation with the screen 14 and the input interface 26, cause the processor to facilitate execution of the operations contemplated by the present invention, i.e., display of the on-screen keyboard 12 and communication of user inputs made thereto through the remote control 16.

One non-limiting aspect of the present invention contemplates the keyboard application facilitating navigation of the keyboard 12 with a cursor 28. The cursor 28 may be positionable relative any one of a plurality of keys shown within the on-screen keyboard 12. Once positioned relative to a desired one of the keys, the remote control 16 may be actuated to select the cursor-highlighted key for input to the operating system 24, which may then process the input for use in support interfacing required to enable product purchasing, navigation of an electronic programming guide (EPG), instigation of video on demand (VOD), textual messaging, web browsing, and other input based operations. The capability to display the keyboard 12 or other interface user selectable keys/features according to signaling communicated from the remote control 16 allows the present invention to facilitate receipt of user inputs while the user is positioned away from the device (STB, etc.) 26.

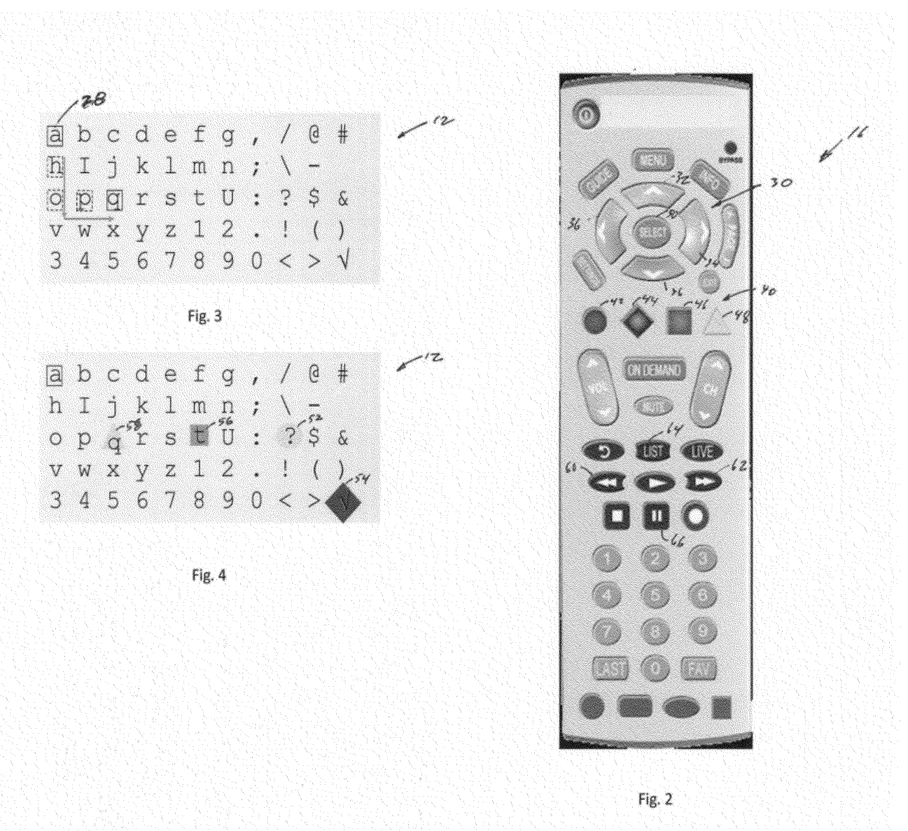

FIG. 2 illustrates the remote control 16 as contemplated by one non-limiting aspect of the present invention. The remote control 16 is shown to include an actuatable plurality of buttons that cause the remote control 16 to emit a corresponding wireless signal to the STB 26. The remote control 16 is shown to be configured to support a number of television related functions, which are textually described on the corresponding button. The remote control 16 may be configured differently with different types of buttons to facilitate operations specific to other types of applications. As such, the present invention is not necessarily limited to television-based remote controls.

The remote control 16 is configured in accordance with the present invention to include a plurality of directional buttons 30. The directional buttons 30 are provided to facilitate input of directional commands that correspond with an up button 32, a right button 34, a down button 36, and a left button 38. The remote control 16 also includes a plurality of shortcut buttons 40. The shortcut buttons 40 are represented with different colors, e.g., red, green, blue, and yellow, and a different shape such that a circle-shaped button 42, a diamond-shaped button 44, a box-shaped button 46, and a triangle-shaped button 48 are included. A select button 50 may be positioned between the directional buttons 30 to facilitate user selection of the cursor highlighted key.

FIG. 3 illustrates the keyboard 12 in accordance with one non-limiting aspect of the present invention. The keyboard application 22 may be configured to automatically position the cursor 28 within a first key (a′ key) upon display of the keyboard 12. The first key in the illustrated configuration is shown to be in a farthest, upper-left quadrant of the keyboard 12. The limited positioning of the cursor 28, however, may be changed to correspond with one of the other keys. The keyboard application 22 may execute a set-up operation that allows the user to change this starting position of the cursor 28 to another one of the keys, e.g., a key more centrally located within the keyboard 12. From the first key starting position, the cursor 28 is shown to travel in a particular manner or pathway to a send key (the ‘q’ key), this pathway results from depression of the corresponding directional button 30 where the cursor 28 moves to an adjoining key with each button actuation.

While there are a number of paths the cursor 28 may following to reach the ‘q’ key, including being directed off one side of the keyboard 12 to appear on the other side, the pathway shown in FIG. 3 represents one scenario where the directional buttons must be actuated on four separate occasion (or depressed for a corresponding length of time) in order to achieve the desired movement of the cursor. Optionally, while the intermediary keys (i.e., the ‘h’ key, ‘o’ key, and ‘p’ key) along the path may be temporarily highlighted with the cursor 28 until the next button actuation, the cursor highlighting during travel may be helpful in allowing the user to visually/identifiably track movement of the cursor from the ‘a’ key to the ‘q’ key. The select button 50 may be selected once the cursor 28 is positioned in order to communicate user input of the corresponding key to the keyboard application operating system 26. A similar process of actuating the directional keys 30 may be repeated in order to move the cursor 28 another key adjoining the ‘q’ key in order to enter additional user inputs.

In the event the user would like to enter the word ‘quartz’ using the directions keys 30, for example, one path starting from the ‘a’ key might be: (down) ‘h’ key, (down) ‘o’ key, (right) ‘p’ key, (right) ‘q’ key, (SELECT) ‘q’ (cumulative clicks: 5); (right) ‘r’ key, (right) ‘s’ key, (right)-‘t’ key, (right) ‘u’ key, (SELECT) ‘qu’ (cumulative clicks: 10); (right) ‘:’ key, (right) ‘?’ key, (right) ‘$’ key, (right) ‘&’ key, (right) ‘o’ key, (up) ‘h’ key, (up) ‘a’ key, (SELECT) ‘qua’ (cumulative clicks: 18); (right) ‘b’ key, (right) ‘c’ key, (right) ‘d’ key, (down) ‘k’ key, (down) ‘r’ key, (SELECT) ‘guar’ (cumulative clicks: 24); (right) ‘s’ key, (right) ‘t’ key, (SELECT) ‘quart’ (cumulative clicks: 27) (down) ‘1’ key, (left) ‘z’ key, (SELECT) ‘quartz’ (cumulative clicks: 30); (left) ‘y’ key, (left) ‘x’ key, (left) ‘w’ key, (left) ‘v’ key, (left) ‘)’ key, (down) ‘Ai’ key, (SELECT) ‘quartz’ (cumulative clicks: 37).

This exemplary path for entering the word ‘quartz’ corresponds with the cursor 28 moving one key at a time to an adjoining key in a sequential pattern characterized by the cursor 28 moving one key with each actuation of the corresponding directional button 30. A total of 37 directional button actuations are thereby needed to enter the work ‘quartz’.

Entering text in this manner can be challenging since the user is required to navigate one key at time in order to reach the desired character. This can be a time consuming process, requiring the user to enter many remote control key presses in order to navigate around the keyboard 12 and select the appropriate characters. This problem becomes worse when the number of keys in the onscreen keyboard 12 grows to allow not only alphabetical characters, but also numbers and symbols. One non-limiting aspect of the present invention contemplates ameliorating this problem by allowing the user to use the shortcut buttons 40 to skip ahead or otherwise shortcut to other portions of the keyboard 12 without having to actuate as many remote control buttons. The shortcut buttons may be used to position the cursor 28 elsewhere without having to actuate the remote control buttons as many times as would otherwise be required with use of the directional buttons 30.

FIG. 4 illustrates the keyboard 12 having a plurality of shortcut references 52, 54, 56, 58 assigned to selected ones of the keys in accordance with one non-limiting aspect of the invention. The shortcuts 52, 54, 56, 58 are shown to be represented with background coloring and/or shaping (shown to include both) representative of the corresponding shortcut button included on the remote control, which for exemplary purposes have been selected to correspond with the ‘q’ key, ‘t’ key, ‘?’ key, and “√’ key. The shortcuts 52, 54, 56, 58 allow the user to move the cursor 28 directly to the corresponding key without having to traverse any intermediary keys, i.e., the cursors may move directly to the shortcut key 52, 54, 56, 58 without highlighting the keys therebetween. The shortcut keys 52, 54, 56, 58, at least in this manner, allow the cursor 28 to be moved to a non-adjoining key so that less key strokes (button actuations) are required to position the cursor 28 to enter a desired word.

With the use of the shortcut keys 52, 54, 56, 58, a corresponding click flow to enter the word ‘quartz’ starting from the ‘a’ key might be: (yellow) ‘q’ key, (SELECT) ‘q’ (cumulative clicks: 2); (blue) ‘t’, (right) ‘U’, (SELECT) ‘qu’ (cumulative clicks: 5); (yellow) ‘q’, (left) ‘p’, (left) ‘o’, (up) ‘h’, (up) ‘a’, (SELECT) ‘qua’ (cumulative clicks: 11); (yellow) ‘q’, (right) ‘r’, (SELECT) ‘guar’ (cumulative clicks: 14); (blue) T, (SELECT) ‘quart’ (cumulative clicks: 16); (down) ‘1’, (left) ‘z’, (SELECT) ‘quartz’ (cumulative clicks: 19); (green) ‘√’ key, (SELECT) ‘quartz’ (cumulative clicks: 21). This exemplary manner for entering the word ‘quartz’ corresponds with a non-sequential process where the cursor 28 is able to shortcut one or more keys. In comparison to the sequential movements associated with the directional button 30 entry noted above, the non-sequential manner of the shortcut key mechanism reduces the number of key clicks from 37 to 21, vastly improving on the time required to enter a textual message.

The shortcuts 52, 54, 56, 58 may be assigned to the any ore more of the keys. The illustrated shortcuts 52, 54, 56, 58 were selected so that each shortcut is assigned a non-adjoining in order to maximize the number of keys bypassed when implementing a shortcut. The ‘√’ key was also selected based on its repeated use to signify the end of a word. The present invention, however, is not necessarily limited to the illustrated positioning and/or number of shortcut keys 52, 54, 56, 58. The allocation of the shortcut keys 52, 54, 56, 58 may be specified by a user, such as during the set-up process, and/or based on prior user history.

Optionally, a MSO or other entity responsible for supporting the STB 26 may be configured to monitor entry habits of the remote control 16 (or user thereof) and to automatically allocate the shortcut keys 52, 54, 56, 58 to the keys most likely to limit the total number of remote control actuations. This may correspond with assigning the shortcuts 52, 54, 56, 58 to the four most popular keys (more shortcuts than four may be assigned if available) and/or assigning the shortcuts 52, 54, 56, 58 relative to other keys in proximity to the four most popular keys (e.g., assigning to other keys than the most popular may be beneficial in insure the shortcut keys 52, 54, 56, 58 are not adjoining and/or to insure the shortcut keys 52, 54, 56, 58 are spread out across the keyboard 12 to achieve the maximum benefit, i.e., reduction in key strokes).

Other shortcuts than those having graphical representations within the on-screen keyboard may be facilitated with the present invention. A fast rewind button 60 and a fast forward button 60 of the remote control 16, for example, may be associated with a ‘skipping’ type of shortcut where actuation may cause the cursor 28 to skip rearwardly/forwardly within the same row a certain number of keys depending on a value associated therewith, e.g., two or three keys. A list button 64 and a pause button 66 may be similarly used to ‘skip’ the cursor 28 in an upward/downward direction within the same column depending on a value associated therewith.

The ability of the present invention to improve the efficiency at which user inputs are communicated may be beneficial in improving operability and user satisfaction with iTV and other applications having a dependency/constraint in so far as being reliant on a somewhat limited input device (e.g., remote control) to manipulate information displayed on a screen (e.g., keyboard). Of course, the present invention is not necessarily limited to particular devices and fully contemplates its application within any environment where a remote control is used to facilitate user inputs related to information shown with in a display or other interface. The present invention also is not necessarily limited to facilitate user inputs separate to the illustrated keyboard 12 and remote control 16. Any other interface may be substituted for the keyboard 12 (e.g., an electronic programming guide (EPG), webpage, etc.) and/or the remote control 16 (e.g., mouse, tablet computer, touch-screen, etc.).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of identifying user inputs to an on-screen keyboard having a plurality of on-screen keys, the method comprising:
positioning of a cursor within the on-screen display according to signals generated in response to user actuation of remote control buttons included on a remote control, the positioning including moving the cursor in a sequential pattern when a first one or more of the remote control buttons is actuated and in a non-sequential pattern when a second one or more of the remote control buttons is actuated; and
identifying user inputs according to the on-screen key in which the cursor is positioned.

2. The method of claim 1 further comprising positioning the cursor in the sequential pattern by moving the cursor one key at a time with each actuation of the first one or more of the remote control buttons.

3. The method of claim 1 further comprising positioning the cursor in the non-sequential pattern by moving the cursor from one on-screen key to a non-adjoining on-screen key.

4. The method of claim 1 further comprising associating one or more of the second one or more of the remote control buttons with a different one of the on-screen keys whereby positioning the cursor in the non-sequential pattern includes automatically moving the cursor to the on-screen key associated with an actuated one of the second one or more of the remote control buttons.

5. The method of claim 1 further comprising:
representing each of the on-screen keys with a unique graphical representation reflective of the corresponding user input; and
providing each of the on-screen keys associated with the second one or more of the remote control buttons with an additional graphical representation reflective of the second one or more of the remote control buttons.

6. The method of claim 5 wherein the additional graphical representation is at least one of a yellow-colored background, a red-colored background, a green-colored background, a blue-colored background, a circle-shaped background, a square-shaped background, a diamond-shape background and a triangle-shaped background

7. The method of claim 1 wherein the second one or more of the remote control buttons is at least one of a yellow-colored button, a red-colored button, a green-colored button, a blue-colored button, a circle-shaped button, a square-shaped button, a diamond-shape button, and a triangle-shaped button.

8. The method of claim 1 wherein the first one or more of the remote control buttons is at least one of an up button, a down button, a left button, and a right button.

9. A method of positioning a cursor relative to a plurality of keys of a keyboard according to signaling generated responsively to actuation of remote control buttons included on a remote control, the method comprising:
facilitating movement of the cursor from a first key to a second key in a first manner in response to at least one actuation of a first one or more of the remote control buttons, the first manner changing positioning of the cursor from the first key to at least one intermediary key prior to be being positioned at the second key; and
facilitating movement of the cursor from the first key to the second key in a second manner in response to at least one actuation of a second one or more of the remote control buttons, the second manner providing a shortcut past the at least one intermediary key such that the cursor changes positioning from the first key directly to the second key.

10. The method of claim 9 further comprising the first manner changing positioning of the cursor starting from the first key to an adjoining key with each actuation of the first one or more of the remote control buttons.

11. The method of claim 9 further comprising the second manner changing positioning of the cursor starting from the first key directly to the second key with a single actuation of the second one or more of the remote control buttons.

12. The method of claim 9 further comprising facilitating assigning each of the second one or more of the remote control buttons to a different one of the plurality of keys, the second key thereby corresponding with a currently actuated one of the second one or more of the remote control buttons.

13. The method of claim 12 further comprising automatically assigning each of the second one or more of the remote control buttons based on a corresponding most popular ones of the plurality of keys as measured from prior user inputs.

14. The method of claim 12 further comprising:
facilitating representation of each of the plurality of keys with a unique icon representative of the corresponding key;
facilitating representation of each of the plurality of keys assigned to the second one or more of the remote control buttons with a unique background representative of the assigned second one or more of the remote control buttons; and
facilitating simultaneously representation of each icon and each background.

15. A computer-readable medium having stored thereon a plurality of instructions including instructions which, when executed by a processor operating in cooperation with a display screen and an input configured to receive wireless signal from a remote control, cause the processor to:
display a keyboard having a plurality of keys on the display screen in response to user actuation of a corresponding button of the remote control;
position a cursor relative to a first key of the plurality of keys upon display of the keyboard;
move the cursor from the first key in response to user actuation of at least one of a plurality of directional buttons of the remote control, the directional buttons specifying an adjoining key to which the cursor moves;
move the cursor from the first key in response to user actuation of at least one of a plurality of shortcut buttons of the remote control, the shortcut buttons each specifying a different one of the plurality of keys to which the cursor moves; and
represent user input based on the one of the plurality of keys having the cursor upon actuation of a select button of the remote control.

16. The computer-readable medium of claim 15 having instructions which cause the processor to separately identify the different one of the plurality of keys with an image reflective of the shortcut button that causes the cursor to move there.

17. The computer-readable medium of claim 15 having instructions which cause the processor to execute a set-up operation during which user actuation of the directional buttons is required to position the cursor within the keyboard to facilitate selection of the keys to be reached upon actuation of the shortcut buttons.

18. The computer-readable medium of claim 15 having instructions which cause the processor to move the cursor no more than one adjoining key at a time for each actuation of the directional buttons.

19. The computer-readable medium of claim 18 having instructions which cause the processor to determine the first key to be a farthest corner of the keyboard and the different one of the plurality of keys moved to with the shortcuts buttons to be non-adjoining to the first key, wherein movement of the cursor from the first key to any one of the different one of the plurality of keys using the directional buttons requires more actuations of the remote control buttons than movement of the cursor to the same key using the shortcut buttons.

20. The computer-readable medium of claim 15 having instructions which cause the processor to represent the user input to an interactive television (iTV) application operating on a settop box (STB), the STB being operable to process television signaling for viewing on the display.
